(19) United States
(12) Patent Application Publication
(10) Pub. No.: US 2023/0032466 A1
(43) Pub. Date: Feb. 2, 2023

(54) THERMALLY INTEGRATED SEPARATION METHOD FOR SEPARATING CARBON DIOXIDE AND NGL

(71) Applicant: L'Air Liquide, Société Anonyme pour I'Etude et I'Exploitation des Procédés Georges Claude, Paris (FR)

(72) Inventors: Michael A. Turney, Houston, TX (US); Vincent Follaca, Houston, TX (US); Abigail Bonifacio, Vallejo, CA (US)

(21) Appl. No.: 17/390,216

(22) Filed: Jul. 30, 2021

(51) Int. Cl. F25J 3/02

(52) U.S. Cl. CPC F25J 3/0266; F25J 3/0219; F25J 2205/80

(57) ABSTRACT

A thermally integrated separation method, including exchanging heat indirectly between an inlet stream and a liquid carbon dioxide/NGL containing stream in a heat exchanger, thereby producing a cold inlet stream and a vaporized carbon dioxide/NGL containing stream, introducing the cold inlet stream into a cryogenic separation unit, thereby producing the liquid carbon dioxide/NGL containing stream and a methane-rich stream, introducing the methane-rich stream into a membrane separation unit, thereby producing a methane rich product stream, and a permeate stream, and introducing the vaporized carbon dioxide/NGL containing stream into a carbon dioxide/NGL separation unit, thereby producing a carbon dioxide rich product stream and a NGL rich product stream. Wherein, at least a portion of the liquid carbon dioxide/NGL containing stream bypasses the heat exchanger and is introduced into the carbon dioxide/NGL separation unit in liquid phase.

### BACKGROUND

Carbon dioxide rich natural gas, as can be found in sour gas or Carbon Dioxide Enhanced Oil Recovery (EOR) resurfacing gas, is commonly composed of carbon dioxide, natural gas (methane), and light hydrocarbons (NGLs). These streams usually also contain impurities such as nitrogen, hydrogen sulfide, and water. The high carbon dioxide content of these gases usually presents a challenge to fully monetizing them. And thus, they require specific separation processes to extract the natural gas, the NGLs, and/or to simply purify the carbon dioxide.

Separation technologies for such applications typically include condensation by external refrigeration, cryogenic separation or distillation, membrane separation, physical or chemical adsorption, or a combination of these. These plants typically produce at a minimum carbon dioxide rich gas, natural gas, or light hydrocarbons (NGL, LPG, Y-grade, etc.) and/or individual hydrocarbon streams, or some combination of these.

Turning to FIG. 1, one method of separation of a gas stream containing carbon dioxide, methane, light hydrocarbons, as well as impurities, is described. This technique is typically used to separate the inlet stream into a carbon dioxide rich stream and a methane rich stream. This process combines cryogenic separation and membrane separation.

Feed stream 101 which contains methane and carbon dioxide, as well as possibly NGLs and other impurities, is introduced into heat exchanger 102, wherein it is cooled by exchanging heat with liquid carbon dioxide rich stream 107 and becomes cold inlet stream 103. Cold inlet stream 103 may be combined with permeate recycle stream 112. In another embodiment, permeate recycle stream 112 may be combined with feed stream 101 and the combined stream cooled in heat exchanger 102. Combined stream 104 is then introduced into cryogenic separation unit 105. Cryogenic separation unit 105 may consist of partial condensation and/or distillation. Cryogenic separation unit 105 may consist of one or several separators (not shown).

In some cases, a demethanization column (not shown) may be added to improve recovery. Two streams are produced, methane-rich stream 106 and carbon dioxide-rich stream 107. Liquid carbon dioxide-rich stream 107 will contain the majority of the NGLs. After exchanging heat with feed stream 101, vaporized carbon dioxide rich stream 108 is sent downstream for further processing such as carbon dioxide/NGL separation, carbon dioxide compression, etc.

Methane-rich stream 106 is then introduced into membrane separation unit 109. Membrane separation unit 109 produces two streams, high-pressure methane-rich retentate stream 110, and low-pressure permeate stream 111. High-pressure methane-rich retentate stream 110 may be composed primarily of methane and trace impurities. Low-pressure permeate stream 111 may be composed primarily of carbon dioxide, methane, and possibly trace components such as ethane, oxygen and helium. At least a portion of low-pressure permeate stream 111 may be split off into permeate recycle stream 112, with remainder permeate stream 113 being disposed of.

Turning to FIG. 2, one distillation method of separating carbon dioxide and a hydrocarbon stream containing propane and higher is described. The skilled artisan would recognize that Ryan-Holmes separation process are known for single column as well as multiple-columns arrangements. As a non-limiting example, FIG. 2 describes a two-column Ryan-Holmes separation scheme.

Feed stream 201 which contains methane, carbon dioxide, and NGLs, is introduced into heat exchanger 202, wherein it is cooled by exchanging heat with bottoms stream 206 and becomes cold inlet stream 203. Cold inlet stream 203 is then introduced into demethanizer column 204, thereby producing methane-rich stream 205, and bottoms stream 206. Bottoms stream 206 contains primarily carbon dioxide and NGLs. After exchanging heat with feed stream 201, vaporized bottoms stream 207 is introduced into carbon dioxide recovery column 208. Carbon dioxide recovery column 208 produces two streams, carbon dioxide rich top stream 209, and NGL-rich bottom stream 210.

Turning to FIG. 3, details of the heat source and sink of a typical carbon dioxide recovery column 208 are described. Low-level heat source 301 provides heat to reboiler 302, thereby providing vaporization heat to the bottom of carbon dioxide recovery column 208. Refrigeration source 303 provides refrigeration to condenser 304, thereby providing reflux to the top of carbon dioxide recovery column 208.

A need exists within the industry for a more efficient, cost-effective, and streamlined process for separating carbon dioxide, methane, and NGL streams from a process stream.

### SUMMARY

A thermally integrated separation method, including exchanging heat indirectly between an inlet stream and a liquid carbon dioxide/NGL containing stream in a heat exchanger, thereby producing a cold inlet stream and a vaporized carbon dioxide/NGL containing stream, introducing the cold inlet stream into a cryogenic separation unit, thereby producing the liquid carbon dioxide/NGL containing stream and a methane-rich stream, introducing the methane-rich stream into a membrane separation unit, thereby producing a methane rich product stream, and a permeate stream, and introducing the vaporized carbon dioxide/NGL containing stream into a carbon dioxide/NGL separation unit, thereby producing a carbon dioxide rich product stream and a NGL rich product stream. Wherein, at least a portion of the liquid carbon dioxide/NGL containing stream bypasses the heat exchanger and is introduced into the carbon dioxide/NGL separation unit in liquid phase

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation of one method of separation of a gas stream containing carbon dioxide, methane, light hydrocarbons, as well as impurities as known in the art.

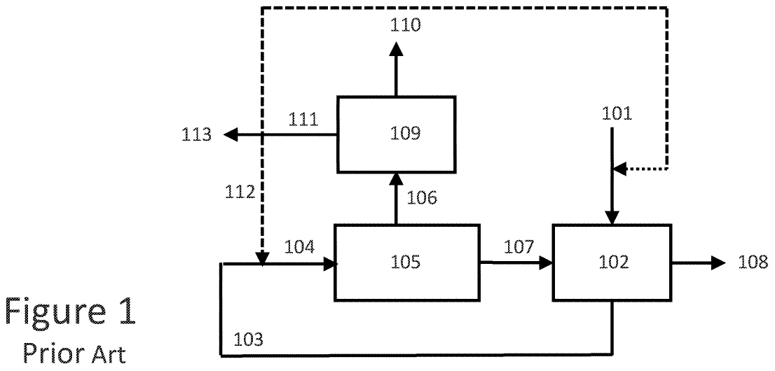

FIG. 2 is a schematic representation of one distillation method of separating carbon dioxide and a hydrocarbon stream containing propane and higher as known in the art.

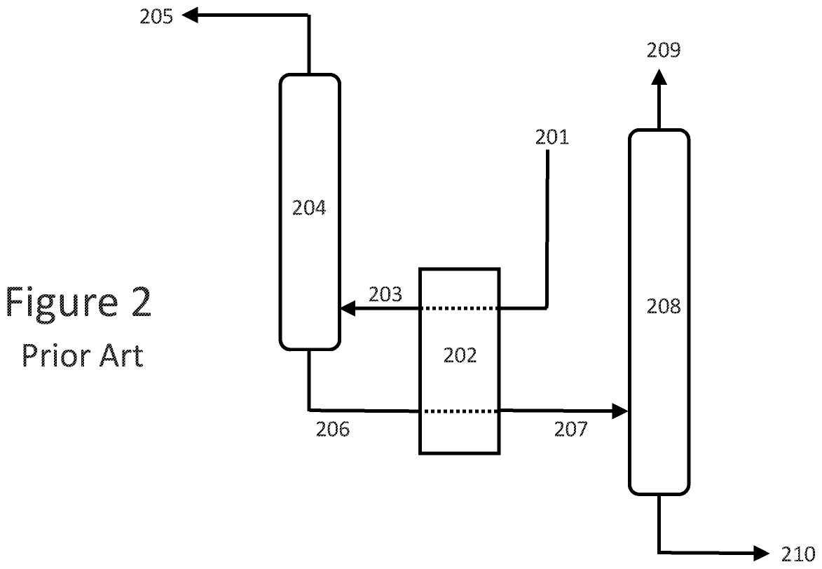

FIG. 3 is a schematic representation of details of the heat source and sink of a typical carbon dioxide recovery column as known in the art.

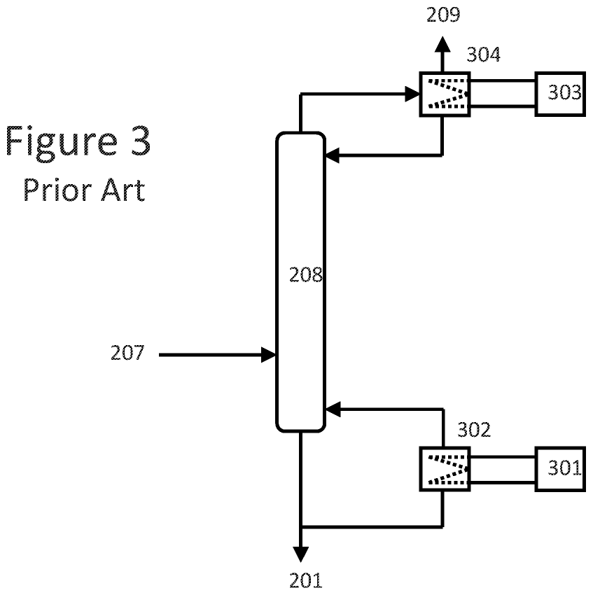

FIG. 4 is a schematic representation of the basic, overall scheme of a process that thermally integrates a carbon dioxide/NGL separation with a carbon dioxide/methane separation, in accordance with one embodiment of the present invention.

FIG. 5 is a schematic representation of a more detailed scheme of the process that thermally integrates a carbon dioxide/NGL separation with a carbon dioxide/methane separation, in accordance with one embodiment of the present invention.

FIG. 6 is a schematic representation of additional details of carbon dioxide/NGL separation unit, in accordance with one embodiment of the present invention.

### ELEMENT NUMBERS

101=feed stream
102=heat exchanger
103=cold inlet stream
104=combined stream
105=cryogenic separation unit
106=methane-rich stream
107=carbon dioxide-rich stream
108=vaporized carbon dioxide-rich stream
109=membrane separation unit
110=high-pressure methane-rich retentate stream
111=low-pressure permeate stream
112=permeate recycle stream
113=remainder permeate stream
201=feed stream
202=heat exchanger
203=cold inlet stream
204=demethanizer column
205=methane-rich stream
206=bottoms stream
207=vaporized bottoms stream
208=carbon dioxide recovery column
209=carbon dioxide-rich top stream
210=NGL-rich bottom stream
301=low-level heat source
302=reboiler
303=refrigeration source
304=condenser
401=feed stream
402=heat exchanger
403=cold inlet stream
404=carbon dioxide/methane separation unit
405=methane-rich stream
406=carbon dioxide/NGL-rich stream
407=vaporized carbon dioxide/NGL-rich stream
408=heat exchanger bypass stream
409=carbon dioxide/NGL separation unit
410=carbon dioxide-rich stream
411=CH3+ rich stream
412=CH4+ rich stream (optional)
413=first portion (of carbon dioxide/NGL-rich stream)
501=feed stream
502=heat exchanger
503=cold inlet stream
504=(optional) dehydration unit
505=dehydrated stream
506=combined stream
507=cryogenic separation unit
508=methane rich stream
509=liquid carbon dioxide/NGL stream
510=vaporized carbon dioxide/NGL stream
511=carbon dioxide/NGL separation unit
512=carbon dioxide rich top stream
513=NGL rich bottom stream
514=heat exchanger bypass stream
515=first portion (of liquid carbon dioxide/NGL stream)
516=methane rich product stream (retentate)
517=permeate stream
518=permeate recycle stream
519=regeneration stream
520=remainder permeate stream
521=membrane separation unit
601=liquid side stream
602=side reboiler
603=low-level heat source
604=vaporized side stream
605=gaseous overhead stream
606=reflux heat exchanger
607=warmed overhead stream
608=reflux stream
609=reflux compressor
610=compressed reflux stream
611=reflux heat exchanger
612=cool reflux stream
613=further cooled reflux stream
614=Joule-Thompson valve
615=cold reflux stream

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

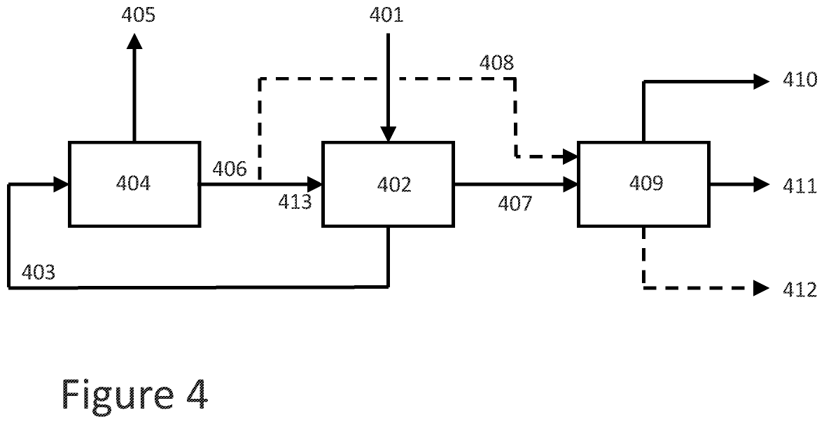

Turning to FIG. 4, the basic, overall scheme of a process that thermally integrates a carbon dioxide/NGL separation with a carbon dioxide/methane separation is described. Feed stream 401 is introduced into heat exchanger 402, wherein it is cooled by exchanging heat with carbon dioxide/NGL rich stream 406 and becomes cold inlet stream 403. Feed stream 401 contains at least methane, carbon dioxide, and NGLs. Cold inlet stream 403 is then introduced into carbon dioxide/methane separation unit 404, which will be described in more detail below. Two streams are produced, methane-rich stream 405 and carbon dioxide/NGL-rich stream 406.

At least a first portion 413 of carbon dioxide/NGL-rich stream 406 exchanges heat with feed stream 401 thus producing vaporized carbon dioxide/NGL-rich stream 407. Heat exchanger bypass stream 408 may bypass heat exchanger 402. Vaporized carbon dioxide/NGL-rich stream 407, and optionally heat exchanger bypass stream 408, is/are introduced into carbon dioxide/NGL separation unit 409, which will be described in more detail below. Two streams are produced, carbon dioxide-rich stream 410 and C3+ rich stream 411. Optionally, C4+ rich stream 412 may also be produced.

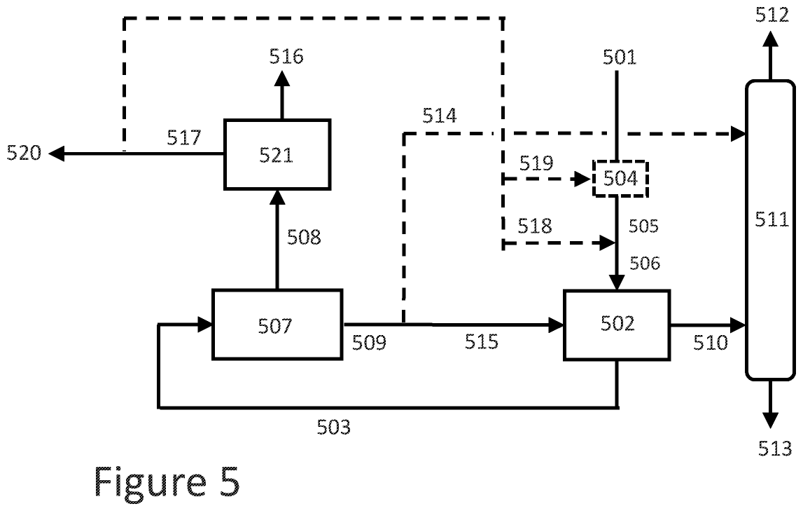

Turning to FIG. 5, a more detailed scheme of the process that thermally integrates a carbon dioxide/NGL separation with a carbon dioxide/methane separation is described. Feed stream 501 is then combined with permeate recycle stream 518, thus forming combined stream 506. Combined stream 506 is then introduced into heat exchanger 502, wherein it is cooled by exchanging heat with a first portion 515 of liquid carbon dioxide/NGL stream 509 and becomes cold inlet stream 503. Feed stream 501 contains at least methane, carbon dioxide, and NGLs. Feed stream 501 may then be introduced into optional dehydration unit 504, thus producing dehydrated stream 505.

Cold inlet stream 503 is then introduced into cryogenic separation unit 507. This may consist of partial condensation and/or distillation. This may consist of one or several separators (not shown).

Two streams are produced, methane-rich stream 508 and liquid carbon dioxide/NGL stream 509. Liquid carbon dioxide/NGL stream 509 will contain the majority of the NGLs. At least a first portion 515 of liquid carbon dioxide/NGL stream 509 exchanges heat with feed stream 501 thus producing vaporized carbon dioxide/NGL stream 510. Heat exchanger bypass stream 514 may bypass heat exchanger 502. Vaporized carbon dioxide/NGL stream 510, and optionally heat exchanger bypass stream 514, is/are introduced into carbon dioxide/NGL separation unit 511. Carbon dioxide/NGL separation unit 511 produces two streams, carbon dioxide-rich top stream 512, and NGL-rich bottom stream 513.

As discussed above, as known in the art, typically carbon dioxide/NGL separation unit 511 would be fed with a fully vaporized liquid stream. Herein only a portion 510 of the feed carbon dioxide/NGL stream is vaporized, with the balance 514 being introduced in liquid form. This reduces the amount of refrigeration required by the distillation section and improves NGL recovery.

Methane-rich stream 508 is then introduced into membrane separation unit 521. Membrane separation unit 521 produces two streams, high-pressure methane-rich retentate stream 516 and low pressure permeate stream 517. Methane-rich stream 516 is then exported as a product stream. Low pressure permeate stream 517 is composed primarily of carbon dioxide, methane, and possibly trace components such as ethane, oxygen and helium. At least a portion of low-pressure permeate stream 517 may be split off into permeate recycle stream 518. At least a portion of low-pressure permeate stream 517 may be split off into regeneration stream 519. The remainder permeate stream 520 being disposed of.

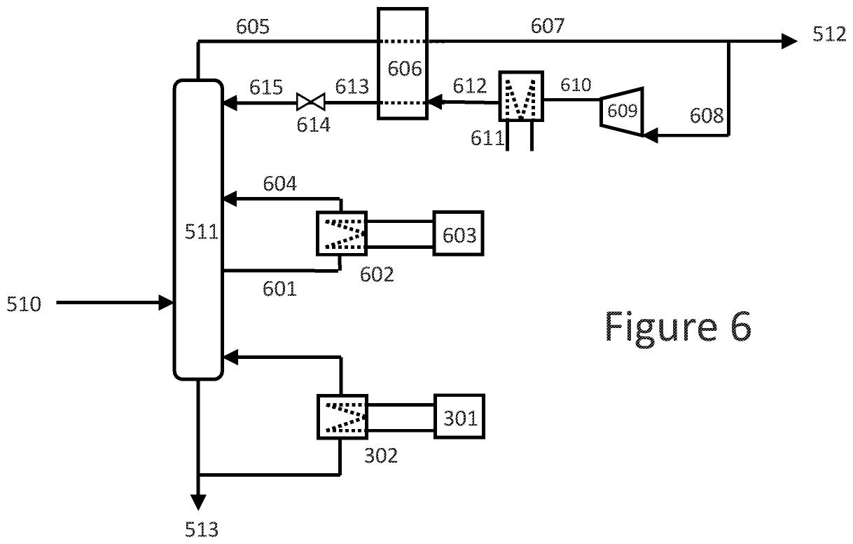

Turning to FIG. 6, additional details of carbon dioxide/NGL separation unit 511 are described. Low-level heat source 301 provides heat to reboiler 302, thereby providing at least a portion of the vaporization heat required at the bottom of carbon dioxide/NGL separation unit 511. A liquid side stream 601 is removed from carbon dioxide/NGL separation unit 511 and vaporized inside reboiler 602 and vaporized side stream 604 is returned to the column. Side reboiler 602 is provided low-level heat from source 603. Low-level heat source 603 may be any suitable heat source available within the process cycle. This reduces the reboiling duty required by reboiler 302.

Gaseous overhead stream 605 is withdrawn from carbon dioxide/NGL separation unit 511 and warmed to ambient temperature in reflux heat exchanger 606, thereby producing warmed overhead stream 607. At least a portion 608 of warmed overhead stream 607 is returned as a reflux stream to the top of carbon dioxide/NGL separation unit 511, with the remaining portion exported as carbon dioxide-rich top stream 512. Reflux stream 608 is compressed to high pressure in reflux compressor 609 thereby forming compressed reflux stream 610. Compressed reflux stream 610 is then cooled in reflux heat exchanger 611. Reflux heat exchanger 611 may be a compressor aftercooler. Such an aftercooler may be of the shell and tube design if the cooling medium is cooling water, or it may be an aerocooler. The pressure at the exit of reflux compressor 609 may be between 40 and 150 bara, preferably between 50 and 130 bara. Compressed Cool reflux stream 612 is further cooled in reflux heat exchanger 606 forming further cooled stream 613. Further cooled stream 613 may be two phase or liquid phase. Further cooled reflux stream 613 may then pass through Joule-Thompson valve 614, thus forming cold reflux stream 615, which is introduced back into the top of carbon dioxide/NGL separation unit 511. Thus, providing additional condensing duty for carbon dioxide/NGL separation unit 511. Cold reflux stream 615 may be at least partially in the vapor phase. Cold reflux stream 615 may be two phase.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A thermally integrated separation method, comprising:
exchanging heat indirectly between an inlet stream and a liquid carbon dioxide/NGL containing stream in a heat exchanger, thereby producing a cold inlet stream and a vaporized carbon dioxide/NGL containing stream,
introducing the cold inlet stream into a cryogenic separation unit, thereby producing the liquid carbon dioxide/NGL containing stream and a methane-rich stream,
introducing the methane-rich stream into a membrane separation unit, thereby producing a methane rich product stream, and a permeate stream, and
introducing the vaporized carbon dioxide/NGL containing stream into a carbon dioxide/NGL separation unit, thereby producing a carbon dioxide rich product stream and a NGL rich product stream,
wherein
at least a portion of the liquid carbon dioxide/NGL containing stream bypasses the heat exchanger and is introduced into the carbon dioxide/NGL separation unit in liquid phase.

2. The thermally integrated separation method of claim 1, wherein at least a portion of the permeate stream is combined with the inlet stream prior to introduction into the heat exchanger.

3. The thermally integrated separation method of claim 1, further comprising a dehydration unit, wherein:
the inlet stream is introduced into the dehydration unit, thus producing a dehydrated stream,
the dehydrated stream is introduced into the heat exchanger, and
at least a portion of the permeate stream is introduced into the dehydration unit as a regeneration stream.

4. The thermally integrated separation method of claim 1, wherein the carbon dioxide/NGL separation unit further comprises a side reboiler and a main reboiler with a reboiler duty, wherein:
a liquid side stream is removed from the carbon dioxide/NGL separation unit, vaporized in the side reboiler, and the vaporized side stream is returned to the carbon dioxide/NGL separation unit,
thereby reducing the reboiler duty.

5. The thermally integrated separation method of claim 1, wherein the carbon dioxide/NGL separation unit further comprises a heat exchanger, a reflux compressor, a reflux cooler, a Joule-Thompson valve, and a condenser with a condenser duty, wherein:
a gaseous overhead stream is removed from the carbon dioxide/NGL separation unit and warmed to ambient temperature in the reflux heat exchanger by indirect heat exchange with a cooled and compressed reflux stream, thereby producing a warmed overhead stream,
a portion of the warmed overhead stream comprises the carbon dioxide rich product stream, and a portion of the warmed overhead stream comprises a reflux stream,
the reflux stream is compressed in the reflux compressor, cooled in the reflux cooler and the resulting cooled and compressed reflux stream exchanges heat with the gaseous overhead stream in the reflux heat exchanger, thereby producing a further cooled reflux stream,
the cooled reflux stream is introduced into the Joule-Thompson valve, and the resulting cold reflux stream is returned to the carbon dioxide/NGL separation unit,
thereby reducing the condenser duty.

6. The thermally integrated separation method of claim 5, wherein the further cooled reflux stream is at least partially condensed.

7. The thermally integrated separation method of claim 5, wherein the further cooled reflux stream is fully condensed.
